(19) United States
(12) Patent Application Publication
(10) Pub. No.: US 2025/0316002 A1
(43) Pub. Date: Oct. 9, 2025

(54) Apparatus for changing figure of digital assistant, method, and vehicle infotainment system

(71) Applicant: CARIAD (China) Co., Ltd., Beijing (CN)

(72) Inventors: Chunlei DENG, Beijing (CN); Xiaopeng LI, Beijing (CN); Yueqin MIAO, Beijing (CN)

(21) Appl. No.: 19/098,603

(22) Filed: Apr. 2, 2025

(30) Foreign Application Priority Data
Apr. 3, 2024 (CN) 202410405284.6

(51) Int. Cl. G06T 11/60; G06V 10/40; G06V 20/59; G06V 40/10; G10H 1/00

(52) U.S. Cl. CPC G06T 11/60; G06V 10/40; G06V 20/59; G06V 40/10; G10H 1/0008; G06T 2210/16; G10H 2210/031

(57) ABSTRACT

The present disclosure provides a control device for changing the figure of a digital assistant, comprising: an image analysis module, configured to determine, on the basis of image data related to at least one person, figure features of the at least one person; and a figure image generation module, configured to change the figure of the digital assistant, so that the changed figure of the digital assistant matches the figure features of the at least one person.

### TECHNICAL FIELD

The present disclosure relates to a vehicle infotainment system of a vehicle, and in particular, to change the figure of a digital assistant on the vehicle.

### BACKGROUND

Currently, in consideration of the interests of consumers and the needs of business development, more and more vehicles are equipped with an in-vehicle digital assistant, which, as a service platform of a car manufacturer, can promote natural interaction between the vehicles and users (including a driver and a passenger) by means of the digital assistant, and improve user experience while building a customer relationship. A digital assistant usually appears on a display screen of a vehicle as a virtual cartoon character Avatar. In order to further enhance user's interest in participation, such digital assistant usually also appears in different clothing styles, to better mobilize user's enthusiasm and participation.

At present, the figure of the cartoon character is mainly changed on the basis of a three-dimensional scene outside the vehicle, for example, a space fence and a time fence. For example, when entering a specific area, or at a specific time, such as a festival, the cartoon character is dressed up in appropriate clothing. Even so, such figure changing is mainly dependent on the selection and matching in an online store or an internal database of the vehicle. For example, on the basis of user's preference or behavior, a clothing file with matching clothing is selected from a pre-established clothing database and is loaded by an animation generation tool or mode to change the figure of the cartoon character. However, it is obvious that due to the limitation of the number of clothing samples in the database or human artistic creativity, perfectly matched clothing may not be found from the database, or changed clothing may not be attractive to a user.

### SUMMARY

The present disclosure provides a solution to enable figure changing of a digital assistant to better fit a figure of a real person, so that figure changing is independent of an existing clothing material in an online store or in an internal database of a vehicle while the fun of figure changing is increased.

Therefore, according to one aspect of the present disclosure, there is provided an apparatus for changing the figure of a digital assistant, comprising: an image analysis module, configured to determine, on the basis of image data related to at least one person, figure features of the at least one person; and a figure image generation module, configured to change the figure of the digital assistant, so that the changed figure of the digital assistant matches the figure features of the at least one person.

According to another aspect of the present disclosure, there is provided a control device for changing the figure of a digital assistant, comprising: a feature extraction module, configured to extract one or more environment features of a current environment of a vehicle; a description generation module, configured to generate a clothing description text on the basis of the environment features; a file generation module, configured to generate a clothing file on the basis of the clothing description text; and a figure image generation module, configured to load the clothing file to change the figure of the digital assistant. According to this solution, an artificial intelligence (AI) model can be automatically driven on the basis of content features of an application or an in-vehicle scene to generate an artistic material, thereby implementing the solution of changing the figure of the digital assistant on the scene; and thus a figure and an outfit of the digital assistant Avatar generated in real time can match the current environment features of the vehicle, so that figure changing of the digital assistant Avatar is more vivid.

### BRIEF DESCRIPTION OF THE DRAWINGS

FIG. 1 shows a configuration of an apparatus for changing the figure of a digital assistant according to an example of the present disclosure;

FIG. 2 shows a configuration of an apparatus for changing the figure of a digital assistant according to another example of the present disclosure;

FIG. 3 shows a configuration of a host system according to an example of the present disclosure;

FIG. 4 is a flowchart of changing the figure of a digital assistant according to an example of the present disclosure; and

FIG. 5 is a flowchart of changing the figure of a digital assistant according to another example of the present disclosure.

### DETAILED DESCRIPTION OF THE EMBODIMENTS

Before any embodiment of the present disclosure is explained in detail, it should be understood that the application of the present disclosure is not limited to the structural details described in the description below or shown in the drawings. The present disclosure can have other embodiments and can practice or implement, in various manners, a solution of changing the figure of an in-vehicle assistant in real time according to the present disclosure.

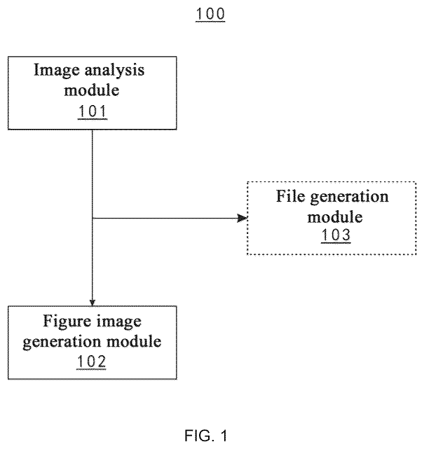

According to one implementation of the present disclosure, the in-vehicle digital assistant Avatar can imitate the clothing of a person in a vehicle, such as a driver or other passengers, without relying on an existing database or material, leading to increased fun. A vehicle cabin is typically provided with an in-vehicle camera therein, which is configured to acquire images of an in-vehicle scene, wherein the images comprise image frames or a video stream of the driver and other passengers. A host system in the vehicle communicates with the camera to acquire these image frames or videos, which are represented by Img below. According to an example of the present disclosure, the host system comprises a figure changing control device. As shown in FIG. 1, the figure changing control device 100 comprises an image analysis module 101 and a figure image generation module 102. The image analysis module 101 receives the image data Img from the camera and recognizes a different person involved therein, such as the driver or the passenger, and therefore acquires image data of the recognized person, which is denoted as FigureImg below. For example, an image FigureImg1 of the driver and images FigureImg2, FigureImg3, etc. of other passengers may be generated. For the image data FigureImg of the recognized person, the image analysis module 101 further performs analysis to determine figure features FigureFeature of the person, wherein the figure features herein may be clothing features cF of the person, for example, including but not limited to: (1) head clothing features cF₁ indicating whether a hat is worn and the style (cF₁₁), color (cF₁₂), logo (cF₁₃), etc. of the hat; (2) neck clothing features cF₂ indicating whether a scarf or tie is worn and the style (cF₂₁), color (cF₂₂), logo (cF₂₃), etc. of the scarf or tie; (3) clothes features cF₃ including style (cF₃₁), texture (cF₃₂), material (cF₃₃), color (cF₃₄), logo (cF₃₅), etc.; and (4) facial features cF₄ indicating whether glasses are worn and the style (cF₄₁), color (CF₄₂), etc. of the glasses. It should be noted herein that the clothing features cF obtained by the image analysis module 101 through analysis is not limited to the example above, and may comprise some of the features, or may further comprise other features reflecting clothing characteristics of the person, without being limited to the specific example above. In addition, the image analysis module 101 herein may determine, using any image analysis technology known in the prior art, these clothing features cF. Thus, as an example, when the driver is wearing a baseball cap, sunglasses, and a black leather jacket while driving, the analysis module 101 may analyze figure features FigureImg1 of the driver, and determine that clothing features of the driver comprise:
CF1: cF₁₁=‘baseball cap’, cF₁₂=‘white’, and cF₁₃=‘none’;
CF3: cF₃₁=‘jacket’, cF₃₂=‘NULL’, cF₃₃=‘NULL’, cF₃₄=‘black’, and cF₃₅=none (‘NULL’ herein represents that the image analysis module 101 cannot determine the relevant features on the basis of the images); and
CF4: cF₄₁=‘sunglasses’, and cF₄₂=dark color.

The figure image generation module 102 is configured to change the figure of the in-vehicle digital assistant Avatar, so that the changed figure of the digital assistant Avatar matches figure features of the analyzed person. For example, for the driver in the example above, who is wearing the sunglasses and the black leather jacket, the figure image generation module 102 also wears a baseball cap, sunglasses and a black top on Avatar when generating the digital assistant Avatar, so as to accurately imitate the driver's clothing. It should be noted herein that the figure of the digital assistant Avatar in the embodiments of the present disclosure is not fixed, but may be changed dynamically. For example, when the driver takes off the cap, sunglasses and leather jacket and only wears a shirt, the figure analysis module 101 may analyze one or more continuously received image frames or video streams about the driver and determine that the figure of the driver has changed. Therefore, the figure analysis module 101 may determine or update to the changed figure features FigureImg' of the driver. Thus, the figure image generation module 102 further changes the figure of the digital assistant Avatar to reflect a change in the figure of the driver, for example, Avatar also only wears a shirt in this example, so as to match the figure features of the driver.

As an example, the figure image generation module 102 may be implemented by a conventional animation generation tool or digital human production tool, e.g., MJ+SD, Unreal Engine, Blender/C4D/MAYA, SadTalker, etc. These tools may load a clothing file in a standard format, to realize the figure changing operation of Avatar. Of course, these tools are also typically used to create or modify other figures of Avatar, such as to change appearance features. The clothing file loaded by these tools usually comprises standard feature elements, which are represented by sE below. These elements comprise a plurality of elements of different types for defining a cloth, which is represented by sE={sE₁, sE₂, sE₃. . . sEₘ,} below, and the elements comprise style, texture, material, olor, logo, etc. To this end, as an example, as shown in FIG. 1, the figure changing control device 100 further comprises a file generation module 103, wherein the file generation module 103 receives the figure feature data cF from the image analysis module 101, and improves values of the standard feature elements sE on the basis of the received figure feature data cF. For example, for the clothing feature data cF3: cF₃₁32 ‘jacket’, cF₃₂=‘NULL’, cF₃₃=‘NULL’, cF₃₄=‘black’, and cF₃₅=none from the image analysis module 101, the file generation module 103 determines that the standard elements of the clothing of Avatar are as follows:
sE_{cloth}=sE₁=‘jacket’, sE₄=‘black’, and sE₅=none. For the texture and material features not provided by the image analysis module (i.e. when cF₃₂=‘NULL’, and cF₃₃=‘NULL’), the file generation module 103 may set, on the basis of factors such as clothing characteristics of a user, that sE₂=‘smooth’, and sE₃=‘leather’. Herein, the file generation module 103 may determine, on the basis of factors such as any conventional habit, feature values that are not provided in the figure features cF but are required for the standard feature elements. It should be noted herein that when the image analysis module 101 may determine the texture feature cF₃₂, for example, when the shirt worn by the driver has a ‘grid’ texture, the analysis module 101 sets cF₃₂ to ‘grid’, so that the file generation module 103 may set sE₃=‘grid’ accordingly. Thus, after determining all of the feature elements sE, the file generation module 103 may form a clothing file ClothFile in a standard file format such as BVH, and provide the clothing file to the figure image generation module 102. Thus, the figure image generation module 102 changes the figure of Avatar by loading the file ClothFile.

According to another example of the present disclosure, the figure features FigureFeature may further comprise appearance features of the person. For example, the image analysis module 101 may analyze the image FigureImg1 of the driver, and determine the appearance features of the driver, such as hairstyle, face shape, or other elements, which are represented by aF herein, wherein aF={aF₁, aF₂, . . . }, and aFᵢ represents an element belonging to the appearance features. Thus, the figure image generation module 102 may generate or modify the appearance of the digital assistant Avatar on the basis of the appearance features aF. For example, when the driver takes off the baseball cap and glasses and only wears the shirt, the image analysis module 101 may determine the hairstyle, the face shape and other elements of the driver, and thus the digital assistant Avatar generated by the figure image generation module 102 is also changed accordingly to match the recognized hairstyle, face shape and the like of the driver.

In the example above, the vehicle infotainment system may configure the camera to be only interested in the driver, that is, to create the figure of the digital Avatar only on the basis of the obtained images of the driver. However, in another example of the present disclosure, the vehicle host system may also indicate the control device 100 to change the figure of the digital assistant on the basis of images of another passenger in the vehicle. To this end, the analysis module 101 determines whether there is a passenger in another position in the vehicle by analyzing the images Img transmitted by the camera. For example, when detecting that there is also a passenger sitting in a co-pilot position, the analysis module 101 extracts images of the passenger from the images Img, which is denoted as FigureImg2 below. Then, as shown above, the analysis module 101 further analyzes FigureImg2 to determine figure features FigureFeature2 of the passenger, which comprises clothing features and/or appearance features, etc. Thus, the figure image generation module 102 generates the digital assistant Avatar on the basis of the figure of the passenger, so that the figure of the assistant presented on a screen matches the passenger.

According to another implementation of the present disclosure, in order to further highlight fun experience, the control device 100 may also selectively change the figure of the assistant Avatar, so that the dressed-up assistant can match the driver or the passenger. As an example, the principle of selective figure changing may be to change the figure of the person who is currently speaking. According to this example, the analysis module 101 receives one or more images Img transmitted by the camera, and performs image processing on the one or more images received, to determine the person who is currently speaking. Herein, the speaker may be determined using the image recognition technology known in the prior art, for example, the speaker may be determined by analyzing the change in a mouth shape of the same person in continuous image frames, or by determining a mouth shape of a person in one image.

According to this embodiment, the image analysis module 101 receives the image data Img from the camera and recognizes that in addition to the driver 1, there are also a passenger together with the driver 1 in the current vehicle, such as a passenger 2, and therefore extracts images of both the driver 1 and the passenger 2, which are denoted as FigureImg1 and FigureImg2 below. For each recognized person, the image analysis module 101 further determines figure features FigureFeature1 and FigureFeature2 of both the driver 1 and the passenger 2, comprising: determining respective clothing features and appearance features thereof. The file generation module 103 may create respective clothing files ClothFile1 and ClotherFile2 on the basis of the figure features FigureFeature1 and FigureFeature2 of both the driver 1 and the passenger 2, respectively.

In addition, the image analysis module 101 further determines, on the basis of the obtained images Img or an obtained image sequence, the person who is currently speaking. For example, when determining that the driver is speaking at the current moment, the image analysis module 101 indicates the figure image generation module 102 to load the clothing file ClothFile1 of the driver and at the same time enables the appearance of the assistant Avatar to match the appearance features of the driver. The digital assistant thus presents as the figure of the driver. When the image analysis module 101 determines, on the basis of subsequently received Img, that the passenger 2 is currently speaking, the image analysis module 101 indicates the figure image generation module 102 to load the clothing file ClothFile2 of the passenger 2 and at the same time enables the appearance of the assistant Avatar to match the appearance features of the passenger 2. The digital assistant thus presents as the figure of the passenger 2.

In another example of the present disclosure, the digital assistant Avatar may also match a figure of a person outside the vehicle in real time. Usually, a mobile phone of a passenger in the vehicle may be connected to the vehicle infotainment system through a wired or wireless link. When the passenger has a video call with a remote person outside the vehicle, the control device 100 may obtain images Img′ of the person outside the vehicle, thereby determining a figure feature FigureFeature″ of the person. Thus, the figure image generation module 102 may create a digital assistant matching the FigureFeature″; and Avatar is restored to a default figure, for example, restored to the figure of the driver, when the video call ends.

In the embodiment described above, the figure of the digital assistant is changed in real time on the basis of the figure of a person in the cabin. However, when the vehicle is not equipped with the in-vehicle camera or the in-vehicle scene is prohibited from being photographed, according to a further embodiment of the present disclosure, the clothing matching an environment may also be selected in consideration of the current environment or application of the vehicle, so that the changed figure of the digital assistant Avatar better fits the current environment. Such a vehicle environment may be a vehicle usage status, e.g., a picture or an image on a current main control screen of the vehicle infotainment system. Since the vehicle infotainment system is usually installed with different controls or applications, these applications present different images during running. For example, the vehicle being in navigation may be driving through an urban road, or a corresponding sea or grassland color is presented when the vehicle passes by the seaside or grassland; and a navigation picture also changes with daytime, evening or dusk as time goes by. In addition, the vehicle environment may also be a sound environment, for example, music played by a multimedia player, such as a radio, of the vehicle or music selected by the user, or a conversation and quarrel, etc. of the user in the vehicle. Of course, the vehicle environment is not limited to the examples above, and may also be any other factors that affect the mood and emotion of a person, such as speed, weather, etc.

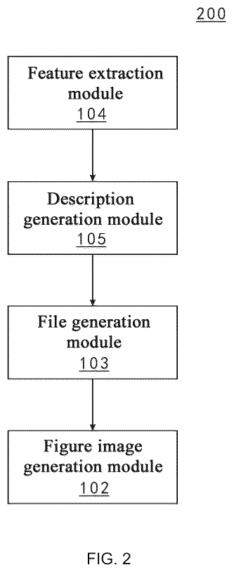

FIG. 2 shows a configuration of a control device for changing the figure of a digital assistant Avatar on the basis of a vehicle environment according to another example of the present disclosure. Descriptions are provided below in combination with a graphical user interface (GUI) on a host system as an example of the vehicle environment.

As shown in the figure, in addition to the file generation module 103 and the figure image generation module 102, a control device 200 further comprises a feature extraction module 104 and a description generation module 105. The feature extraction module 104 is configured to extract desktop features of the GUI of the host system, for example, to capture image features or picture features of the GUI. As an example, it is assumed that the current vehicle is in a navigation mode currently, the captured image features may be a navigation interface image GUImg, and thus, a plurality of feature elements F are determined on the basis of the captured image GUImg and include, but are not limited to, a time feature F1, such as evening or a specific moment, a road feature F2, such as a current urban road or rural road or highway, a color feature F₃ of a current picture, a driving destination F₄, etc. As an example, it is assumed that, on the basis of the current navigation interface, current time displayed on the interface is determined as 17:35, and a dark yellow navigation background and buildings on both sides of a road that have been passed by indicate that the user is currently on the way off work. Thus, the feature extraction module 104 may determine the following feature elements: F1=evening, F2=urban road, F3=warm yellow, and F4=off work by reading and analyzing the image features of the current GUI.

It should be noted herein that the extracted time features may further comprise date features and holiday attributes calculated from the date. For example, when the current date is May 1, it may be determined that the day is the labor holiday. Therefore, the feature extraction module 104 may combine the evening or specific moment+date+holiday attributes to form the final time feature F1, for example, F1=evening+May 1+holiday. Accordingly, the destination F4 is modified to ‘vacation’. In addition, the above only schematically shows that the four feature elements are extracted on the basis of the image features of the GUI interface. Apparently, however, the present disclosure is not limited thereto, but instead may comprise more or fewer other feature elements, so N is used herein to represent the number of the feature elements.

In addition, it should be noted that part of the feature elements F above, such as F1 (=evening), F2 (=urban road), and F3 (=warm yellow), are visual features presented on the interface image GUImg, so these elements F may be determined from the interface image GUImg by means of the image analysis technology, but may also be determined on the basis of data inside the host system. For example, it may be determined, on the basis of the current system time, that it is evening, and the current road features may be determined on the basis of map data. Any image analysis technology known in the prior art may be used herein to obtain the feature element F. Thus, the feature extraction module 104 provides the feature element F=[F₁, F₂, . . . , F_{N}] to the description generation module 105.

The description generation module 105 is configured to generate a clothing description text ClothDes on the basis of the environment features F. In this example, a trained generative artificial intelligence (AI) clothing description language model CDLM may be called to process the feature elements F of the extracted desktop image features to generate the clothing description text ClothDes. In this example, before providing the feature elements to the description generation module 105, the feature extraction module 104 may perform necessary processing on the feature elements [F₁, F₂, . . . , F_{N}], for example, converting the feature elements into standard feature vectors which are then provided as input parameters to the clothing description language model CDLM. For ease of description, the feature vectors herein are still represented by [F₁, F₂, . . . , F_{N}].

In the present disclosure, the clothing description text ClothDes describes an appropriate clothing matching suggestion in the current vehicle environment, and the clothing description language model CDLM is equivalent to a clothing consultant providing the clothing description suggestion ClothDes by integrating various feature elements in the current environment. For example, for F1=evening, F2=urban road, F3=warm yellow, and F4=off work in the example above, the clothing description text ClothDes may be “Match daily wear of a white-collar worker on/off work, with warm yellow as a main color”.

It should be noted herein that, in the example above, the feature extraction module 104 analyzes the extracted image GUImg into the various feature elements [F₁, F₂, . . . , F_{N}] and provides the feature elements to the model CDLM. However, in another example, the feature extraction module 104 may also directly provide the image features GUImg to a trained clothing description language model CDLM′, and the CDLM′ may directly process the image to form the clothing description text ClothDes.

According to this embodiment, the file generation module 103 receives the clothing description text ClothDes from the description generation module 105, and creates a clothing file ClothFile on the basis of the clothing description text ClothDes. As described in the example above, the clothing file ClothFile herein may comprise a plurality of clothing elements sE traditionally for defining the clothing, such as style sE₁, logo or accessory sE₂, color coordication sE₃, material sE₄, and texture sE₅ representing clothing style elements. The style sE₁ comprises suits, short sleeves, and denim clothing, and may further comprise information such as collar types and sleeve types. The color coordication sE₃ comprises warm and cold colors (or a specific color), a glossy color, and the like. The logo sE₂ may be a pattern related to an environment, for example, may be the glowing moon at night. The material sE4 indicates materials constituting the clothing, i.e., clothing fabric, such as natural fibers (cotton, linen, silk, wool, and leather), chemical fibers (nylon, and polyester), and blends. The texture sE₅ indicates patterns on the clothing fabric, such as checks, stripes, or solid colors. The clothing file ClothFile herein may adopt a format commonly used in the prior art, such as a BVH format. Thus, the generated clothing file ClothFile in the standard format comprises the clothing elements, such as overall style, shape, color, fabric, and accessory.

According to this example of the present disclosure, the file generation module 103 processes the clothing description text ClothDes by calling a trained generative artificial intelligence clothing resource generation model CRGM. Herein, the file generation module 103 may pre-process the clothing description text ClothDes, for example, in a semantic segmentation manner and the like, to divide the clothing description text ClothDes into a predetermined number of vectors v1, v2, v3, . . . , and then the model CRGM processes the vectors v and outputs the clothing elements (sE₁, sE₂, sE₃ . . . , sE_{M}) representing the clothing, etc., wherein M represents the number of M elements for defining the cloth. Herein, the elements sE₁, sE₂, sE₃, sE₄, sE₅, etc. output by the model CRGM may directly indicate the corresponding clothing elements. For example, for ClothDes in the example above: “Match daily wear of a white-collar worker on/off work, with warm yellow as a main color”, an output of the model CRGM is sE₁=casual overskirt, sE₂=NULL (no logo), sE₃=light blue, sE₄=cotton, and the texture sE₅=spots, etc. Thus, the file generation module 103 may create, on the basis of the element sE generated by the model CRGM, the clothing file ClothFile in a common format such as BVH, wherein the file contains these element information E.

The figure image generation module 102 loads the clothing file ClothFile generated by the file generation module 103, thereby changing the figure of the digital assistant Avatar, for example, changing the clothing of the digital assistant Avatar from the style such as suits at work to relaxed casual clothing off work. Herein, the figure image generation module 102 may load the clothing file ClothFile by executing a traditional application, thereby changing the figure of the digital assistant Avatar.

From the description above, it can be found that in the present disclosure, the figure changing of the digital assistant Avatar is generated in real time, without relying on any database or any existing clothing option, but is determined in real time on the spot on the basis of the current environment by automatically driving the generative artificial intelligence models CDLM, CRGM, etc. Therefore, the figure changing may be adjusted accordingly with the significant change in the environment, so that the user can feel more intimate and have better man-machine experience.

According to the embodiments of the present disclosure, the clothing description language model CDLM and the file generation model CRGM may be generated by training an artificial intelligence neural network. Such artificial intelligence neural network may be a convolutional neural network or another network composed thereof, such as a multilayer perceptron MLP network. Herein, the training manner known in the prior art may be used to determine the CDLM and CRGM, for example, by collecting a large number of samples collected in various different environments for training and generation. Such different environments comprise, for example, different GUI interface picture samples under different scenes, times, or other conditions; and a sound sample in the vehicle, such as music or a broadcast played by a multimedia playing apparatus such as a radio or other players, or passengers' communications, etc. Moreover, for each sample, a professional clothing matching suggestion, such as an expert suggestion from an art clothing consultant or a large number of user surveys, is used as a clothing description sample label ClothDes_Label, to form a training data set {DataSample, ClothDes__Label}. DataSample herein represents environment data obtained in various environments, such as image features, and music clips. Thus, a model parameter of the CDLM may be determined by learning {DataSample, ClothDes_Label} by means of data training, and a model parameter of the CRGM may be determined by learning {ClothDesSample, Cloth_Lable}. Cloth_Lable herein is clothing matching for each vehicle environment, and may be specified manually or by other means during a sample collection process, and ClothDesSample represents a sample of the clothing description text, and may be derived from a training result of the model CDLM, or derived by other means, such as a language sample generated manually. During a sample training process, the samples from the various different environments may be mixed up to train the models CDLM and CRGM, so that the models are universally applicable. In addition, during the sample training process, the models CDLM and CRGM may be trained separately, to facilitate observation and evaluation of the clothing description text ClothDes of the CDLM, and of course, the models CDLM and CRGM may be trained jointly, to reduce evaluation costs.

According to a further embodiment of the present disclosure, during the process of training the models CDLM and CRGM, corresponding weighting may further be performed on the basis of the importance of each of the image elements F and the clothing elements sE, so that the changed clothing of the assistant Avatar is more matched with a factor with great influence. For example, in the example described above, according to a pre-set weight allocation strategy, higher weights may be assigned to the urban road F₂ and the color F₁, while correspondingly weights of the time F₁ and the like are reduced. Thus, the clothing description text and clothing file obtained on the basis of the models CDLM and CRGM can better highlight a key factor to be considered.

According to the present disclosure, the trained models CDLM and CRGM may be applicable to various environments. For example, in another example of the present disclosure, the vehicle environment is music in the vehicle as an example. Usually, music that a user prefers can reflect a mood, an emotion, or the like of the user. Thus, when the figure of the digital assistant Avatar can match the music, better riding and interactive experience can be provided to the user. Therefore, according to an embodiment of the present disclosure, the figure of the digital assistant Avatar may be changed in real time on the basis of the music played in the vehicle. As an example, it is assumed that the user opens a music App on a vehicle host to play music online, or the user's mobile phone is connected to the vehicle host system through communication technology such as in-vehicle Bluetooth, and the vehicle host system is playing music played by the user on the mobile phone, such as rock songs.

The feature extraction module 104 is configured to extract music style features of the music that is currently playing, including, for example, a genre F1 (e.g., a folk, a pop, a rock, a rap, electronic music, ACG, classical music, and a jazz), a rhythm F1, a scale F2, a timbre F3, a theme F4, etc. As an example, it is assumed that the current user is listening to “Molihua (Jasmine)”, the feature extraction module 104 can extract feature elements of “Molihua (Jasmine)” on the music app. For example, N elements such as the genre F1-‘folk’ may be determined. Before providing the elements to the description generation module 105, the feature extraction module 104 converts the feature elements [F₁, F₂, . . . , F_{N}] into standard feature vectors, and provides the standard feature vectors as large model input parameters to the description generation module 105 for processing.

The description generation module 105 processes these music style elements [F₁, F₂, . . . , F_{N}] to generate a clothing description text ClothDes. Similarly, the description generation module 105 processes, by calling the clothing description model CDLM, the extracted music feature elements F to generate the clothing description text ClothDes. As described above, the clothing description model CDLM is an AI model obtained in advance through training in the different types of environments. Thus, for the currently playing music “Molihua (Jasmine)”, after the features are processed by the model clothing description model CDLM, ClothDes may be generated, for example: “a figure wearing jasmine themed-dress, with white as the main color”.

Similar to the description above, the file generation module 103 pre-processes the clothing description text ClothDes, for example, by means of semantic segmentation, etc., to divide the clothing description text ClothDes into a predetermined number of vectors v1, v2, v3, . . . , and then calls the model CRGM to process the clothing description text ClothDes, thereby generating a clothing file ClothFile. As described above, the file contains clothing elements such as style or design sE1, logo or accessory sE2, color coordination sE3, a material sE4, and a texture sE5. Still in the example of the music “Molihua (Jasmine)”, the style sE1=dress, the accessory sE2=bowknot, the color sE3=white, the material sE4=silk, the texture sE5=pure color, etc. Thus, the file generation module 103 may generate a clothing file ClothFile in, for example, a BVH format on the basis of the element sE generated by the model. The figure image generation module 102 thus loads the generated clothing file ClothFile, thereby changing the figure of the digital assistant Avatar.

Similarly, for a music environment, during the process of training the CDLM and CRGM models, corresponding weights are chosen on the basis of the importance of the elements, so that the changed clothing of the assistant matches an influencing factor with high importance. Herein, the pre-set weight allocation strategy may be used, for example, higher weights may be assigned to the genre F1 and the timbre F3, while correspondingly the weights of other elements are reduced.

It should be noted herein that although the examples above describe, by using the GUI desktop background and the music as examples respectively, the embodiments of changing the figure of Avatar, the present disclosure is not limited thereto, and different environments may also be comprehensively considered for figure changing, for example, both the GUI desktop background and the music are considered for figure changing. To this end, according to one embodiment of the present disclosure, the feature extraction module 104 may extract respective feature elements on the basis of a GUI desktop and a music background, such as a picture element (F₁, F₂, . . . . F_{N}) on the basis of the GUI desktop, and a music style element extracted on the basis of the music background. For ease of description, (F₁′, F₂′, . . . . F_{N}′) is used herein for representation of the music style element. Subsequently, the feature extraction module 104 combines the two types of elements, for example, F_{1′}+F_{1→}F₁″, F_{2′}+F_{2→}F₂″, F_{3′}+F_{3→}F₃″, . . . , F_{N′}+F_{N→}F_{N}″, then performs vector conversion on updated vectors (F₁″, F₂″, . . . , F_{N}″), and provides the converted vectors to the file generation module 103 for subsequent processing. Thus, after processing is performed on the basis of the models CDLM and CRGM, a clothing file ClothFile is generated in comprehensive consideration of an environment factor, and the figure image generation module 102 changes the figure of Avatar. It may be found that in the present disclosure, the large models are automatically driven, on the basis of the content features of the scene and application, to generate an artistic material, which reduces a manual design process, and can realize a real-time generative Avatar figure changing.

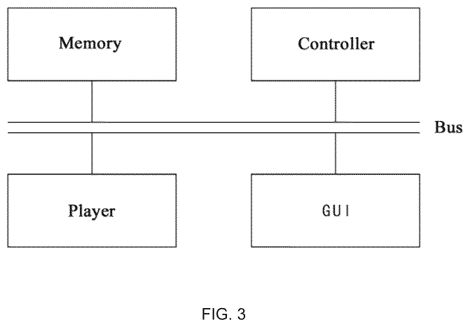

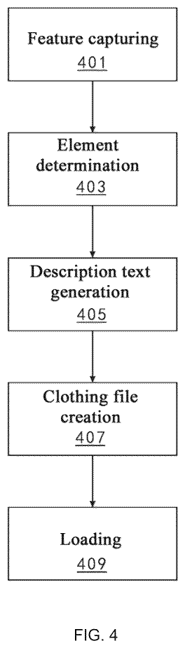

In the example of the present disclosure described above, the control apparatus 100 is implemented as a module, but it should be noted herein that each module may be a program module implemented by a hardware circuit, firmware, or a software program, and implements a module function under the execution of a controller or other processors of the vehicle host system. Therefore, according to another example of the present disclosure, as shown in FIG. 3, such a host system comprises: a graphical user interface GUI and/or a multimedia player or a speaker or a microphone, a memory storing a computer-readable program, and at least one controller or processor. In addition, the memory may further store the models CDLM and CRGM. The procedure of changing the figure of the digital assistant by the host system is described below with reference to FIG. 4 by still using a GUI desktop as an example.

At step 401, features of the GUI desktop are captured. For example, it is assumed that the current vehicle is in a navigation mode, and therefore the captured image features may be a navigation interface image GUImg on the GUI desktop.

At step 403, on the basis of the captured image GUImg, N feature elements F are determined, for example, a time feature F₁, such as evening or a specific moment; a road feature F₂, such as a current urban road feature or a rural road or a highway; and a color feature F₃ of a current picture, and a driving destination F₄, etc. It is assumed that the current time displayed on the current interface is 17:35, and a dark yellow navigation background and buildings on both sides of a road passed by indicate that the user is currently on the way off work. Thus, the feature elements may be determined as follows: F1=evening, F₂=urban road, F3=warm yellow, F4=off work, etc.

At step 405, a clothing description text ClothDes is generated on the basis of the environment features [F₁, F₂, . . . , F_{N}]. In this example, the trained clothing description language model CDLM is called to process the extracted desktop image features [F₁, F₂, . . . , F_{N}] to generate the clothing description text ClothDes. For example, in this example, the clothing description text ClothDes generated by the clothing description model CDLM may be “Match daily wear of a white-collar worker on/off work, with warm yellow as a main color”.

At step 407, a clothing file ClothFile is created on the basis of the clothing description text ClothDes. Herein, the clothing file ClothFile may comprise a plurality of clothing elements sE traditionally for defining the clothing, such as style or design sE₁, logo or accessory sE₂, color coordination sE₃, material sE₄, and texture sE₅. According to the example of the present disclosure, the clothing description text ClothDes is preprocessed, for example, by means of semantic segmentation or the like, to divide the clothing description text ClothDes into a predetermined number of vectors v1, v2, v3, . . . . Then, the trained artificial intelligence-based clothing generation model CRGM is called to process the vectors v and output the clothing elements (sE₁, sE2, sE3, . . . , sE_{M}) representing the clothing. As an example, for the example above “Match daily wear of a white-collar worker on/off work, with warm yellow as a main color”, an output of the model AIGC is sE₁=casual trousers, sE₂=NULL (i.e., no logo), sE₃=dark blue, sE₄=wool (it is winter now on the basis of time), a texture sE₅=pure color, etc. Then, on the basis of the element sE generated by the model CRGM, the clothing file ClothFile is created in a common format such as a BVH format, wherein the file comprises these element information E.

At step 409, the clothing file ClothFile is loaded, to change the figure of the digital assistant Avatar, for example, the clothing of the digital assistant Avatar is changed from a suit and a tie on work to relaxed casual clothing off work. Herein, the figure image generation module 102 may load the clothing file ClothFile by executing a traditional application, thereby changing the figure of the digital assistant Avatar.

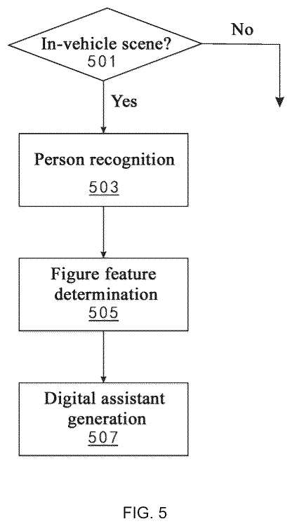

FIG. 5 shows a control procedure of changing the figure of a digital assistant by a vehicle infotainment system according to another example of the present disclosure. First, at step 501, whether an in-vehicle scene image in can be obtained is determined, for example, by the vehicle infotainment system which determines whether an in-vehicle camera is equipped and whether the camera is turned on. When the in-vehicle camera is not equipped or the camera is not turned on, it's switched to the control procedure shown in FIG. 4, so as to change the figure of the assistant Avatar on the basis of a vehicle environment. When it's determined at step 501 that the in-vehicle scene image Imgcan be obtained, it proceeds to step 503.

At step 503, a different person involved therein, such as a driver or a passenger, are recognized on the basis of the received image data Img, and image data of the recognized person is obtained, which is denoted as FigureImg below. For example, an image FigureImg1 of the driver may be generated.

At step 505, the image FigureImg1 of the driver is analyzed to determine figure features FigureFeature of the driver, including clothing features cf, and optional appearance features aF of the driver.

Subsequently, at step 507, the figure of the digital assistant Avatar is changed, so that the changed figure of the digital assistant Avatar matches the figure features of the driver. According to different implementations of the present disclosure, the figure of the digital assistant may be changed dynamically on the basis of the person. The image frames or video stream related to the person, such as the driver in this example, is analyzed, and it may be determined that the figure features of the person have changed. Therefore, when the figure of the digital assistant is changed, the figure of the digital assistant also reflects the change in the figure features of the person. For example, assuming that currently the driver is wearing a baseball cap, sunglasses and a black leather jacket, when the digital assistant Avatar is generated, Avatar is also wearing a baseball cap, sunglasses, and a black top, so as to accurately imitate driver's clothing. Correspondingly, when the driver takes off the cap, sunglasses and leather jacket and only wears a shirt, the figure of the digital assistant Avatar is further changed to match the figure feature of only wearing a shirt, and the appearance of Avatar is simultaneously modified to match crew cut and square face features of the driver.

In another example of the present disclosure, the vehicle infotainment system may further change the figure of the digital assistant on the basis of images of all passengers in the vehicle. To this end, at step 503, passengers in all positions in the vehicle including the driver are determined by analyzing the images Img transmitted by the camera. For example, when it is detected that there is also a passenger sitting in a co-pilot position, an image of the passenger is also extracted from the images Img, which is denoted as FigureImg2 below. Then, at step 505, figure features FigureFeature2 of the passenger are determined by analyzing FigureImg2, including clothing features and/or appearance features, etc.

Then, at step 507, the person who is currently speaking is determined on the basis of one or more received images. Herein, the speaker may be determined using the image recognition technology known in the prior art, for example, the speaker may be determined by analyzing the change in a mouth shape of the same person in continuous image frames, or by determining a mouth shape of a person in one image. For example, when it is determined that the driver is speaking at the current moment, the figure of the digital assistant Avatar is made to match the figure features FigureFeature1 of the driver; or when it is determined that the passenger is currently speaking, the figure of the digital assistant Avatar is made to match the figure features FigureFeature2 of the passenger.

Although different embodiments of the present disclosure are described above in combination with specific examples, a person skilled in the art also recognizes that various illustrative logic modules and method steps described in combination with the disclosure herein may be implemented as electronic hardware, computer software, or a combination thereof. For example, the control apparatus for changing the figure of the digital assistant Avatar according to the present disclosure may be implemented as a processor or a main controller and a memory, wherein the memory stores various modules in a form of a computer program, and the processor may implement the method of the present disclosure by executing these modules. In addition, another embodiment of the present disclosure provides a machine-readable medium which stores a machine-readable instruction. The machine-readable instruction, when executed by a processor, causes the processor to execute any of the methods disclosed above in the description. These embodiments also fall within the scope of protection of the present disclosure.

1. A control device for changing the figure of a digital assistant, comprising:
an image analysis module, configured to determine, on the basis of image data related to at least one person, figure features of the at least one person; and
a figure image generation module, configured to change the figure of the digital assistant, so that the changed figure of the digital assistant matches the figure features of the at least one person.

2. The control device according to claim 1, wherein the image data comprises a video stream or one or more image frames captured at different times;
the image analysis module further determines, on the basis of the image frames or video stream related to the at least one person, changes in the figure features of the at least one person; and
the figure image generation module changes the figure of the digital assistant, so that the changed figure of the digital assistant reflects the changes in the figure features of the at least one person.

3. The control device according to claim 1, wherein the figure features comprise at least one of clothing features and appearance features of the person;
the control device further comprises a file generation module, configured to generate a first clothing file on the basis of the clothing features, wherein the first clothing file comprises a plurality of elements defining the clothing, and the plurality of elements comprise at least one of: style, texture, material, color, and logo; and
the figure image generation module loads the first clothing file to change the figure of the digital assistant.

4. The control device according to claim 1, wherein the image analysis module receives the image data captured by an in-vehicle camera, and the at least one person comprises one or more of a driver and a passenger.

5. The control device according to claim 3, wherein the image analysis module further recognizes, on the basis of one or more pieces of the image data, a currently speaking person, and outputs the figure features of the currently speaking person; and
the figure image generation module switches the figure of the digital assistant, so that the changed figure of the digital assistant remains consistent with the figure features of the currently speaking person.

6. The control device according to claim 3, further comprising:
an environment detection module, configured to extract one or more environment features of a current environment of a vehicle; and
a description generation module, configured to generate a clothing description text on the basis of the environment features, wherein
the file generation module is further configured to generate a second clothing file on the basis of the clothing description text; and
the figure image generation module is configured to selectively load the first clothing file and the second clothing file to change the figure of the digital assistant.

7. The control device according to claim 6, wherein the current environment comprises a current host interface of a vehicle host, and the environment features comprise image features extracted from the host interface of the vehicle.

8. The control device according to claim 6, wherein the current environment comprises background music being played by the vehicle, and the environment features comprise music style features.

9. The control device according to claim 8, wherein the description generation module processes the environment features using a trained clothing description language model to generate the clothing description text, and the clothing description text describes clothing characteristics that matches the current environment.

10. The control device according to claim 9, wherein the clothing description language model assigns different weights to the environment features when processing the environment features.

11. The control device according to claim 9, wherein the file generation module processes the clothing description text using a trained clothing generation model, wherein the second clothing file comprises a plurality of elements defining the clothing, and the plurality of elements comprise at least one of: style, texture, material, color, and logo.

12. A method for changing the figure of a digital assistant, comprising:
determining, on the basis of image data related to at least one person, figure features of the at least one person; and
changing the figure of the digital assistant, so that the changed figure of the digital assistant matches the figure features of the at least one person.

13. The method according to claim 12, wherein the image data comprises a video stream or one or more image frames captured at different times, and the method further comprises:
determining, on the basis of the image frames or video stream related to the at least one person, changes in the figure features of the at least one person; and
changing the figure of the digital assistant, so that the changed figure of the digital assistant reflects the changes in the figure features of the at least one person.

14. The method according to claim 12, wherein the figure features comprise at least one of clothing features and appearance features of the person; and
the method comprises: receiving the image data captured by an in-vehicle camera, wherein the at least one person comprises one or more of a driver and a passenger.

15. (canceled)

16. The control device according to claim 20, wherein the current environment comprises:
the graphical user interface, wherein the environment features comprise image features extracted from the graphical user interface; and/or
music being played by the vehicle, wherein the environment features comprise music style features.

17.-19. (canceled)

20. A control device for changing the figure of a digital assistant, comprising:
an environment detection module, configured to extract one or more environment features of a current environment of a vehicle;
a description generation module, configured to generate a clothing description text on the basis of the environment features;
a file generation module, configured to generate a clothing file on the basis of the clothing description text; and
a figure image generation module, configured to load the clothing file to change the figure of the digital assistant.
